(19) United States
(12) Patent Application Publication
(10) Pub. No.: US 2014/0186866 A1
(43) Pub. Date: Jul. 3, 2014

(54) Glucose Control Test Strip

(71) Applicant: GENERAL ELECTRIC COMPANY, Schenectady, NY (US)

(72) Inventors: David Wayne Duckert, Menomonee Falls, WI (US); Barry Howard Ginsberg, Wyckoff, NJ (US)

(73) Assignee: GENERAL ELECTRIC COMPANY, Schenectady, NY (US)

(21) Appl. No.: 13/728,423

(22) Filed: Dec. 27, 2012

(51) Int. Cl. G01N 27/327

(52) U.S. Cl. CPC G01N 27/3272
USPC 435/14; 29/592.1

(57) ABSTRACT

A control test strip for glucose that includes a cover that forms a fluid path when affixed to the test strip substrate. The fluid path includes a glucose deposit area formed by drying a glucose solution on to the cover or onto the test strip substrate. The control test strip further includes a pair of electrodes having a first end positioned within an enzyme coating area and a second end positioned to deliver an electrical signal to the glucose meter. The enzyme coating area also lies within the fluid path. When a user places a drop of water at the opening of the fluid path, capillary action pulls the water into the fluid path, mixing the water with the dried glucose so that a solution having a known glucose concentration is formed. This glucose solution then mixes with the enzyme and a reading is made by the glucose meter.

### FIELD

The present application is directed to the field of home blood glucose monitoring kits. More specifically, the present application is directed to the field of glucose control test strips in home blood glucose monitoring kits.

### BACKGROUND

Referring to FIG. 1, a conventional glucose test strip 10 is illustrated. The glucose test strip 10 is fashioned from a test strip substrate 12. This test strip substrate 12 may be fashioned from plastic or a heavy stock paper, or any other substance known in the art utilized to fashion test strip substrates 12. The glucose test strip further includes electrodes 16 that connect the glucose test strip 10 to a glucose meter (not shown) and extend along the surface of the glucose test strip 10 to an enzyme coating area 18. The electrodes 16 are ordinarily carbon or metallic traces, but may be any other known conductor or semiconductor utilized to effectuate a path for carrying electrical current from the enzyme coating area 18 to the glucose meter.

The enzyme coating area 18 defines where a reactive enzyme with or without a mediator is used to coat the test strip substrate 12 covering both electrodes 16. A test strip cover 14 includes a blood channel 22. The test strip cover is also fashioned from plastic, heavy stock paper, or clear mylar and the blood channel 22 may be formed by bending the test strip cover 14 or by molding the test strip cover 14 such that when the test strip cover 14 is placed over the test strip substrate 12 and attached therewith, a blood channel 22 extends from the blood application point 20 over the entire enzyme coating area 18. In another embodiment there may be more than one active electrode and they may be opposed to one another. The test strip substrate 12 further includes a calibration code 24. In operation, when the test strip substrate 12 is inserted into the glucose meter, the glucose meter reads the calibration code 24 to derive information from the calibration code 24 such as whether this particular batch of test strips reads high, reads low, the age of the test strips, usually due to variance in the enzymes used to produce the test strip 10.

Further in operation, it should be understood that the test strip cover 14 is permanently affixed to the test strip substrate 12. A test subject lances their finger or another portion of their body to draw a sample of blood, and places the test strip substrate 12 to touch the blood sample at the blood application point 20. The test subject's blood is drawn to the enzyme coating area 18 via capillary action, and the enzyme with or without a mediator reacts with the glucose in the blood to create an electrical current that is carried by the electrodes to the glucose meter. The level of electrical current is then measured by the glucose meter, converted to glucose concentration, and displayed to the user.

Home blood glucose monitoring kits generally include a small bottle of control solution to test the device and test strips 10. The control solution is essentially sugar water. It is applied to the same test strip 10 as blood would be as described. The resulting glucose reading is then compared to the control solution glucose concentration to confirm the accuracy of the system.

However, the control solution can be easily contaminated or concentrated by the patient. Leaving the cap off for an extended period of time will result in the water evaporating and an increased glucose concentration and/or contamination, resulting in error. Also, such solution is oftentimes messy. Eliminating the need for such solution while providing a specific control test would be useful

### SUMMARY

In one aspect of the present application, a control test strip includes a test strip substrate, electrodes fashioned on the test strip substrate, an enzyme coating area fashioned on the test strip substrate, at least portion of the electrodes configured within the enzyme coating area, wherein the enzyme coating area includes an enzyme that reacts with glucose. The control strip also includes a test strip cover fashioned to cover the enzyme coating area and the portion of the electrodes in the enzyme coating area, such that when the test strip cover is fastened to the test strip substrate, a fluid channel is formed from a first edge of the substrate to the enzyme coating area and a glucose deposit area formed in the fluid channel, wherein the glucose deposit area includes a dried glucose deposit having a known glucose measure, such that when a non-glucose solution is delivered to the fluid channel, the dried glucose deposit is dissolved and a resulting glucose solution having a known concentration reacts with the enzyme.

In another aspect of the present application, a method of forming a control test strip includes fashioning electrodes on a test strip substrate, forming an enzyme coasting area on the test strip substrate, configuring at least a portion of the electrodes within the enzyme coating area, wherein the enzyme coating area includes an enzyme that reacts with glucose, fashioning a test strip cover to cover the enzyme coating area and the portion of the electrodes in the enzyme coating area. This method of the present application also includes fastening the test strip cover to the test strip substrate, such as a fluid channel is formed from a first edge of the substrate to the enzyme coating area, and forming a glucose deposit area in the fluid channel, wherein the glucose deposit area includes a dried glucose deposit having a known glucose measure, such that when a non-glucose solution is delivered to the fluid channel, the dried glucose deposit is dissolved and the resulting glucose solution having a known concentration reacts with the enzyme.

In another aspect of the present application, a home glucose test control strip includes a pair of electrodes fashioned on a surface of a test strip substrate, an enzyme coating area fashioned on the test strip substrate, a first end of the pair of electrodes configured within the enzyme coating area, and a second end of the pair of electrodes configured to provide an electrical connection to a glucose monitor, wherein the enzyme coating area includes an enzyme that reacts with the glucose, a test strip cover fashioned to cover the enzyme coating area and the first end of the pair of electrodes, such that when the test strip cover is fastened to the test strip substrate, a fluid channel is formed from a first edge of the substrate to the enzyme coating area, and a dried glucose deposit having a known glucose measure formed in the fluid channel, such that when a water sample is delivered to the fluid channel, the dried glucose deposit with dissolved and the resulting glucose solution having a known concentration reacts with the enzyme, such that an electrical signal is carried to the glucose meter by the pair of electrodes.

### BRIEF DESCRIPTION OF THE FIGURES

FIG. 1 is a graphical representation illustrating a glucose test strip.

FIG. 2 is a graphical representation illustrating an embodiment of the present application.

FIG. 3 is a graphical representation illustrating an embodiment of the present application.

FIG. 4 is a flow chart illustrating an embodiment of the present application.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

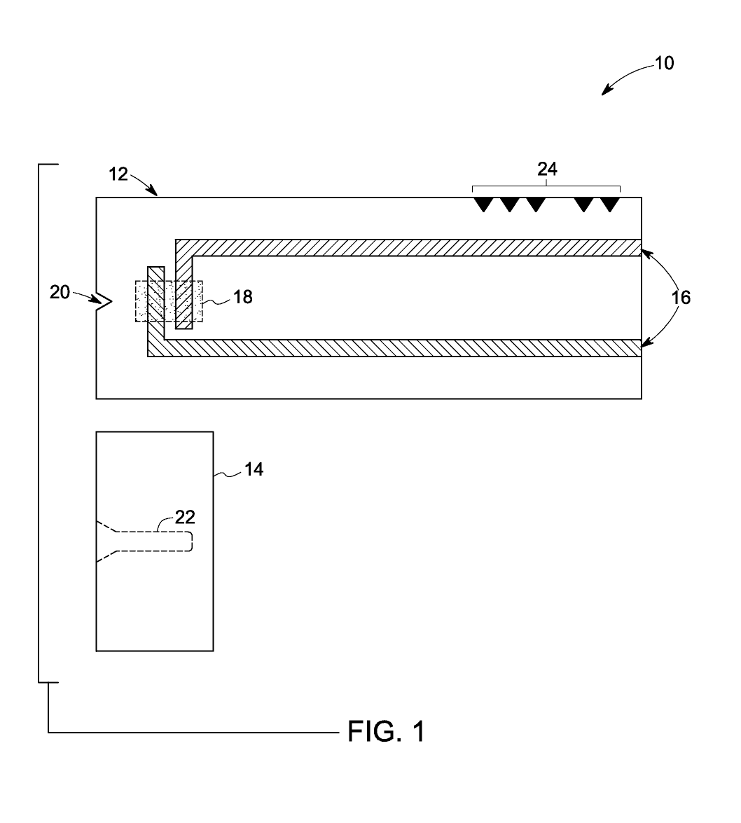

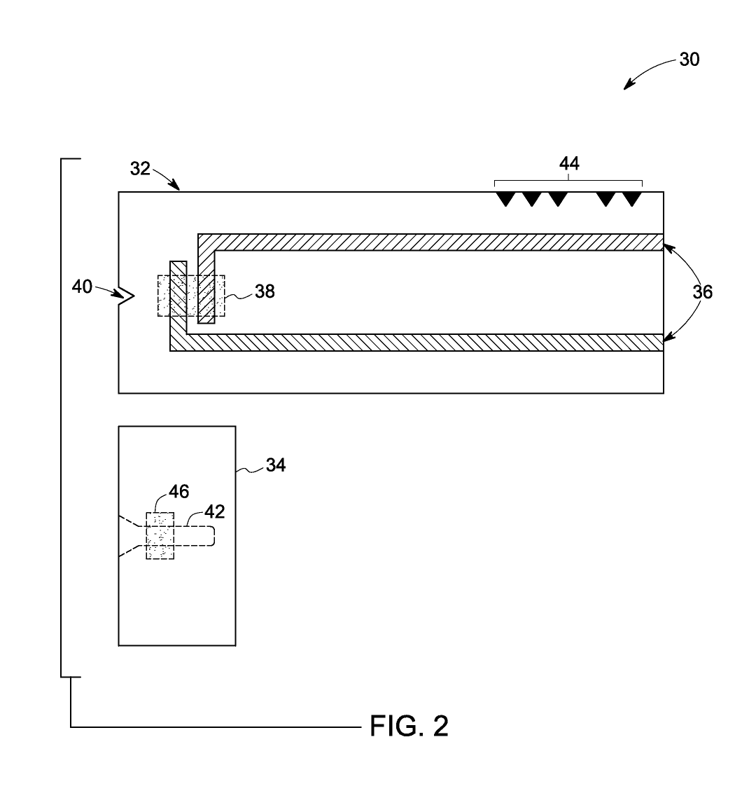

Referring to FIG. 2, an embodiment includes a control test strip 30. This control test strip 30 is fashioned from a test strip substrate 32 made of known test strip substrate 32 materials such as plastic or heavy stock paper. The control test strip 30 also includes electrodes 36 fashioned on the surface of the test strip substrate 32, wherein the first end of the electrodes 36 connect to a glucose meter and the opposite end of the electrodes 36 are in contact with an enzyme coating area 38. This control test strip 30 also includes a test strip cover 34 fashioned from plastic, heavy stock paper, a metallic foil, clear mylar or other known materials used for such applications, and also includes a fluid channel 42 formed by either bending or molding the test strip cover 34 such that when the test strip cover 34 is fashioned over the test strip substrate 32, a fluid channel 42 is formed between the test strip cover 34 and the test strip substrate 32. In this embodiment, a glucose deposit area 46 is created on the surface of the test strip cover that faces the test strip substrate, at least partially formed within the fluid channel 42. The control test strip 30 is identified by the control code 44, that codes the control test strip 30 as a control test as opposed to a normal, conventional blood test strip as shown in the FIG. 1 embodiment. The control code 44 may be fashioned as a series of notches formed on the test strip substrate that may be read by the glucose meter, a plurality of indentations on the surface of the substrate that may also be read by the glucose meter, or an electrical or optical feature on the surface of the substrate, that may be read by an appropriately enabled glucose meter as well. Accordingly, the control code may be accomplished utilizing a variety of known or innovative methods, including electrical parameters, optical features, or mechanical methods as described above.

Still referring to FIG. 2, in operation, the test strip cover 34, after the glucose deposit area 46 is added to the surface of the fluid channel 42, it is affixed to the test strip substrate 32. In other embodiments, the glucose deposit area 46 may be placed in the fluid channel 42 through the fluid application point 40 after the cover 34 is affixed to the substrate 32. The dried glucose sample is placed in the deposit area by any known method in the art for drying and affixing a sample of glucose to a plastic, paper, mylar, foil or other materials used to manufacture such test strips and covers. The glucose, as a dry pellet may also be deposited in the fluid channel 42 above or below the enzyme coated region 38. It is also contemplated that in other embodiments, trehalose or similar substances may be added to the glucose in order to increase the rate of dissolution of the glucose, to ensure that the glucose is dissolved and in a quicker fashion. It is also contemplated that the glucose deposited area 46 could include non-crystalline, for example freeze-dried, glucose or other forms of glucose to increase the rate of dissolution. This control test strip 30 is not designed to received blood, or even a control solution as described in FIG. 1, but instead allows a user to place a drop of water at the application point 40 so that this drop of water is drawn by capillary action down the fluid channel 42 through the glucose deposit area 46 such that a known glucose concentration arrives at the enzyme coating area 38. This known glucose concentration is then tested by the glucose meter receiving a current from the electrodes 36, without the need for the control solution as described above. Once the glucose meter discovers that the control test strip 30 is indeed a test strip through the control code 44, the glucose meter may take the reading and mark it as such. This in essence excludes the reading taken from the control test strip 30 from the other readings taken by the user that include blood samples so that these control readings are not included in the user's blood sample records. The control test strips 30, in some embodiments, may even be fashioned to have a slightly different appearance from typical glucose test strips 10 in order to differentiate them from those traditional test strips 10 for the user.

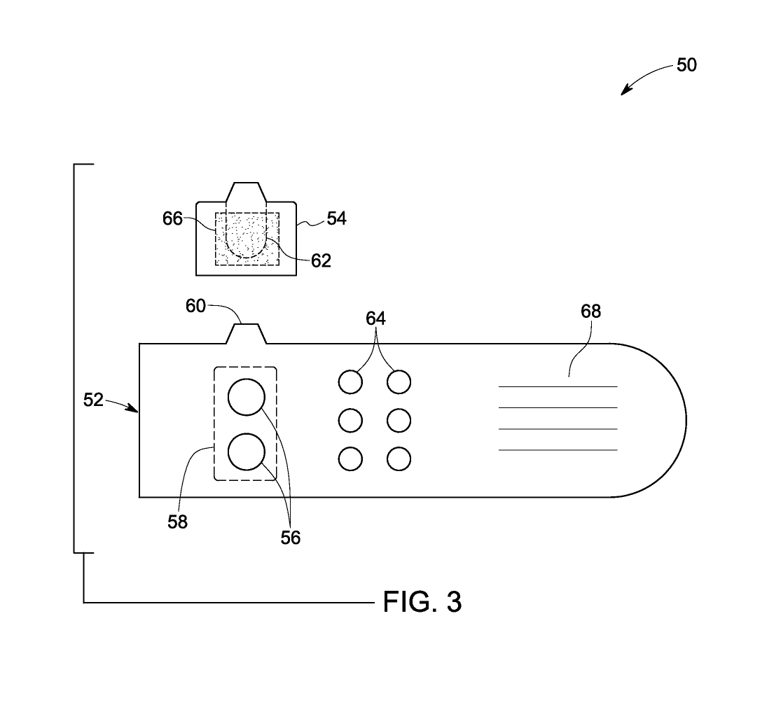

It should be understood that the control test strip 30 of FIG. 2 is exemplary only, and that the control test strip 30 can be fashioned in many other configurations for various glucose meters. Specifically, referring to FIG. 3, a further embodiment includes a control test strip 50 including a test strip substrate 52 and a test strip cover 54. In operation, the test strip cover 54 is affixed to the test strip substrate 52 such that the fluid channel 62 is again treated with a glucose deposit area 66 and the resulting fluid channel 62 is one that receives a drop of water in a fluid application point 60 and draws the water down the fluid channel 62, through the glucose deposit area 66 to deliver a known glucose concentration to the enzyme coating area 58. The electrodes 56 then measure the known glucose concentration and it is read by the glucose meter. Again, this control test strip 50 includes a control coding 64 that allows the glucose meter to determine that this strip is indeed a control test strip 50 and not a patient blood test strip. This embodiment also includes a portion of the test strip substrate 52 fashioned into a handle 68 for ease of use by the test subject.

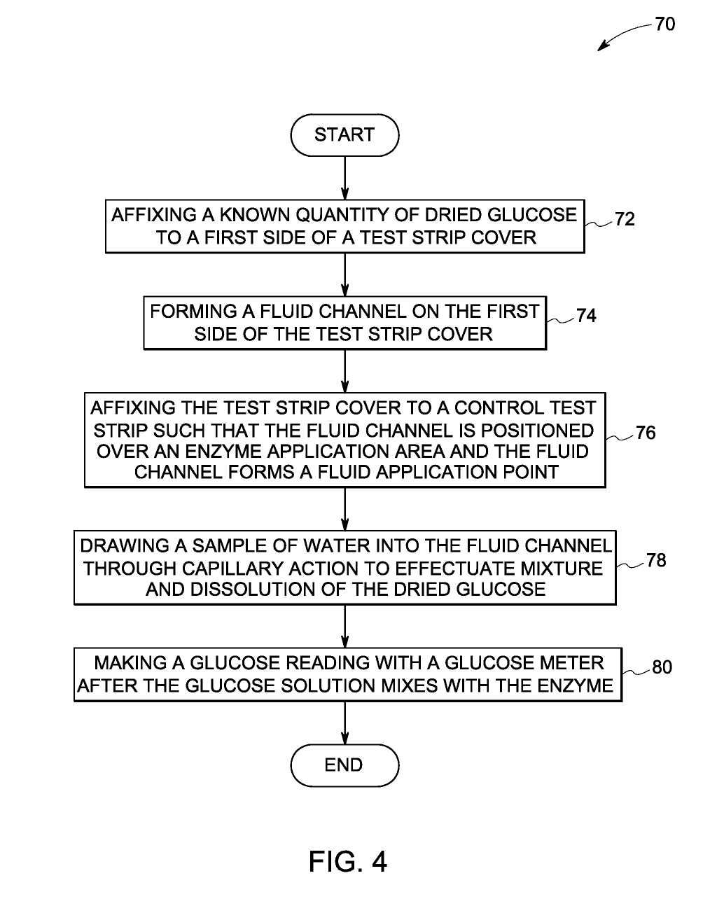

Referring now to FIG. 4, an embodiment of a method of the present application is illustrated. In step 72, a known quantity of dried glucose is affixed to a first side of a test strip cover of a control test strip. In step 74, a fluid channel is formed on the first side of the test strip cover. In other embodiments, it should be noted that the fluid channel may be formed on the first side of the test strip cover prior to the known quantity of dried glucose being affixed to the cover. In step 76, the test strip cover is affixed to a control test strip such that the fluid channel is positioned over an enzyme application area and the fluid channel forms a fluid application point and a path from the fluid application point to the enzyme application area through the dried glucose. In step 78, a sample of water is drawn into the fluid channel through capillary action to effectuate mixture and dissolution of the dried glucose, forming a solution of water and glucose with a known glucose concentration. In step 80, a glucose reading is made with a glucose meter after the glucose solution having a known glucose concentration mixes with the enzyme.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A control test strip comprising:
a test strip substrate;
electrodes fashioned on the test strip substrate;
an enzyme coating area fashioned on the test strip substrate, at least a portion of the electrodes configured within the enzyme coating area, wherein the enzyme coating area includes an enzyme that reacts with glucose;
a test strip cover fashioned to cover the enzyme coating area and the portion of the electrodes in the enzyme coating area, such that when the test strip cover is fastened to the test strip substrate, a fluid channel is formed from a first edge of the substrate to the enzyme coating area; and
a glucose deposit area formed in the fluid channel, wherein the glucose deposit area includes a dried glucose deposit having a known glucose measure, such that when a non-glucose solution is delivered to the fluid channel, the dried glucose deposit is dissolved and a resulting glucose solution having a known concentration reacts with the enzyme.

2. The control test strip of claim 1, wherein the glucose deposit is formed by drying glucose to the test strip cover prior to the cover being fastened to the substrate.

3. The control test strip of claim 1, wherein the glucose deposit is a glucose pellet attached to the test strip cover before fastening the cover to the substrate or inserted into the fluid channel after the test strip cover is fastened to the substrate.

4. The control test strip of claim 1, wherein a substance is added to the glucose deposit in order to increase a rate of dissolution of the dried glucose deposit.

5. The control test strip of claim 1, further including a control code fashioned on the test strip substrate, such that the control code is read by a glucose meter, wherein the glucose meter then identifies the control test strip as providing a control reading.

6. The control test strip of claim 5, wherein the control code is fashioned as a mechanical control code such as a series of notches formed on a second edge of the test strip substrate, or a plurality of indentations on the surface of the test strip substrate.

7. The control test strip of claim 5, wherein the control code is fashioned as an electrical or an optical feature on the surface of the test strip substrate.

8. The control test strip of claim 1, wherein the electrodes are fashioned on the test strip substrate completely within the enzyme coating area.

9. The control test strip of claim 1, wherein the end of the fluid channel configured at the first edge of the test strip substrate includes a fluid application point to receive the non-glucose solution, such that the non-glucose solution is drawn from the fluid application point into the fluid channel by capillary action.

10. The control test strip of claim 1, further including a handle fashioned from a portion of the test strip substrate.

11. A method of forming a control test strip comprising:
fashioning electrodes on a test strip substrate;
forming an enzyme coating area on the test strip substrate;
configuring at least a portion of the electrodes within the enzyme coating area, wherein the enzyme coating area includes an enzyme that reacts with glucose;
fashioning a test strip cover to cover the enzyme coating area and the portion of the electrodes in the enzyme coating area;
fastening the test strip cover to the test strip substrate, such that a fluid channel is formed from a first edge of the substrate to the enzyme coating area; and
forming a glucose deposit area in the fluid channel, wherein the glucose deposit area includes a dried glucose deposit having a known glucose measure, such that when a non-glucose solution is delivered to the fluid channel, the dried glucose deposit is dissolved and a resulting glucose solution having a known concentration reacts with the enzyme.

12. The method of claim 11, further including forming the glucose deposit by drying glucose to the test strip cover prior to fastening the cover to the substrate.

13. The method of claim 11, wherein the glucose deposit is a glucose pellet and further including attaching the glucose pellet to the test strip cover before fastening the cover to the substrate or inserting the glucose pellet into the fluid channel after fastening the test strip cover to the substrate.

14. The method of claim 11, further including adding a substance to the glucose deposit in order to increase a rate of dissolution of the dried glucose deposit.

15. The method of claim 11, further including fashioning a control code on the test strip substrate, such that the control code is read by a glucose meter, wherein the glucose meter then identifies the control test strip as providing a control reading.

16. The method of claim 15, wherein the control code is fashioned as a mechanical control code such as a series of notches formed on a second edge of the test strip substrate, or a plurality of indentations on the surface of the test strip substrate.

17. The method of claim 15, wherein the control code is fashioned as an electrical or an optical feature on the surface of the test strip substrate.

18. The method of claim 11, further including fashioning the electrodes on the test strip substrate completely within the enzyme coating area.

19. The method of claim 11, further including drawing the non-glucose solution from a fluid application point into the fluid channel by capillary action.

20. A home glucose test control strip comprising:
a pair of electrodes fashioned on a surface of a test strip substrate;
an enzyme coating area fashioned on the test strip substrate, a first end of the pair of electrodes configured within the enzyme coating area, and a second end of the pair of electrodes configured to provide an electrical connection to a glucose monitor, wherein the enzyme coating area includes an enzyme that reacts with glucose;
a test strip cover fashioned to cover the enzyme coating area and the first end of the pair of electrodes, such that when the test strip cover is fastened to the test strip substrate, a fluid channel is formed from a first edge of the substrate to the enzyme coating area; and
a dried glucose deposit having a known glucose measure formed in the fluid channel, such that when a water sample is delivered to the fluid channel, the dried glucose deposit is dissolved and a resulting glucose solution having a known concentration reacts with the enzyme, such that an electrical signal is carried to the glucose meter by the pair of electrodes.
